(19) United States
(12) Patent Application Publication
(10) Pub. No.: US 2018/0342869 A1
(43) Pub. Date: Nov. 29, 2018

(54) ALTERNATING CURRENT/DIRECT CURRENT HOME SMART MICRO-GRID COORDINATION SYSTEM AND OPERATION METHOD THEREOF

(71) Applicant: GUANGDONG UNIVERSITY OF TECHNOLOGY, Guangzhou, Guangdong (CN)

(72) Inventors: Yun ZHANG, Guangzhou, Guangdong (CN); Guidong ZHANG, Guangzhou, Guangdong (CN); Sizhe CHEN, Guangzhou, Guangdong (CN)

(73) Assignee: GUANGDONG UNIVERSITY OF TECHNOLOGY, Guangzhou, Guangdong (CN)

(21) Appl. No.: 15/760,925

(22) PCT Filed: Jan. 10, 2017
(86) PCT No.: PCT/CN2017/070775

§ 371 Date: Mar. 16, 2018

(30) Foreign Application Priority Data
Oct. 26, 2016 (CN) 201610947750.9

(51) Int. Cl. H02J 3/02; H02J 3/28; H02J 3/38

(52) U.S. Cl. CPC H02J 3/02; H02J 3/381; H02J 3/28

(57) ABSTRACT

An alternating current/direct current home smart micro-grid coordination system is provided, which includes an alternating current power quality screening modulator, a direct current power quality screening modulator and a power coordination module, where the power coordination module is configured to receive parameters of buses detected by the alternating current power quality screening modulator and the direct current power quality screening modulator, perform optimization calculation to obtain optimal solutions of a voltage on the power quality-insensitive load alternating current bus and a voltage on the power quality-insensitive load direct current bus, and issue an instruction to control the alternating current power quality screening modulator and the direct current power quality screening modulator to adjust the voltage on the power quality-insensitive load alternating current bus and the voltage on the power quality-insensitive load direct current bus.

This application claims the priority to Chinese Patent Application No. 201610947750.9, titled “ALTERNATING CURRENT/DIRECT CURRENT HOME SMART MICRO-GRID COORDINATION SYSTEM AND OPERATION METHOD THEREOF”, filed on Oct. 26, 2016 with the State Intellectual Property Office of People's Republic of China, which is incorporated herein by reference in its entirety.

### FIELD

The present disclosure relates to the field of micro-grids, and in particular to an alternating current/direct current home smart micro-grid coordination system and an operation method thereof

### BACKGROUND

A micro-grid, which is also referred to as a microgrid, is a small-scale power generation and distribution system consisting of a distributed power supply, a power storage apparatus, an energy conversion apparatus, a load, a monitor and protection apparatus, and the like. The micro-grid is an autonomous system which can achieve self-control, self-protection and self-management, and may operate in connection with an external power grid or operate separately. The micro-grid is proposed for achieving flexible and efficient application of distributed power supplies, and solving grid-connection problems of a great number of distributed power supplies in various forms. Suggestions of State Council on Strengthening Urban Infrastructure Construction recites “promote the intellectualization of urban power grids to meet a demand for grid-connection of new energy power and distributed power generation systems, optimize demand side management, and gradually achieve a bi-directional interaction between power systems and users; aiming at improvement of utilization rate, security and reliability level, and power quality of power systems, further strengthen key technology research and pilot demonstration of urban smart power distribution networks”. Therefore, requirements on future power grids mainly include two aspects, which are green and low carbon, and high efficiency and high reliability. With respect to green and low carbon, the power grid is required to meet the connection demand of a large amount of extensively distributed new energy power sources, for achieving replacement of traditional energy generation by clean energy on the power supply side. With respect to high efficiency and reliability, all potential “resources” which are helpful to maintain a balance between power supply and demand are to be fully discovered for constructing the power grid, acceptability of the power grid for the new energy power generation is to be enhanced, and power quality and power supply reliability are to be improved.

FIG. 1 shows a structure of a conventional home power grid. In a home, power required by some electric devices such as a fan, a washing machine, and a dishwasher is directly supplied by the 220V mains supply. With diversification of home power uses, an increasing number of electric devices such as a computer, a laptop, a cell phone, an electric car, and a direct current variable-frequency air conditioner, essentially require a direct current, in which case an alternating current needs to be converted into a direct current for use. Approximately 10% of the electric power is consumed due to this intermediate AC to DC conversion.

FIG. 2 shows a conventional home micro-grid. This structure is adopted by most families in Europe and America. This structure includes both alternating current electric devices and direct current electric devices. In addition, the power of a newly added new energy direct current module needs to be inverted into an alternating current by means of DC to AC inversion, and then converted back into a direct current to supply to the direct current electric devices. More than 20% of electric power is consumed due to this conversion.

The new energy module shown in FIG. 2 supplies power intermittently, which affects normal operation of a power quality-sensitive load, and stability of the power grid. Therefore, the new energy power generation module cannot be completely connected to the power grid. A conventional solution is to use a battery to store power. However, the battery has a high cost and a limited power capacity. In addition, service life of the battery is shortened due to frequent charging and discharging.

In a conventional power grid, a “line” is a basic scheduling unit, which results in difficulty in scheduling of single electric devices, and active adjustment function of a precious “resource”, i.e., the “power quality-insensitive load”, in balancing between the power supply and the power demand is not fully utilized. Therefore, all loads on a certain line are passively cut off in a case of imbalance between the power supply and the power demand, resulting in losses for users of user devices which are passively powered off. In such a scheduling manner, reliability of the power grid is further reduced if a great number of new energy modules with randomly varying power generation amount are forcedly connected. In addition, the intermittency of the conventional new energy module has a great impact on the stability of the power grid.

Therefore, it is desirable to provide a new home smart micro-grid in which the alternating current and the direct current are used in combination with each other, to address the above technical issue in the conventional technology that the intermittency of the conventional new energy has a great impact on the stability of the power grid.

### SUMMARY

An alternating current/direct current home smart micro-grid coordination system and an operation method thereof are provided according to the embodiments of the present disclosure, to address a technical issue that the intermittency of the conventional new energy has a great impact on the stability of the power gird, so that 100% of new energy is connected to the power grid and the alternating current/direct current home smart micro-grid coordination system is purely resistive and is maintained at constant power in a time-division manner with respect to a mains supply.

A coordination system for an alternating current-direct current home smart micro-grid is provided according to an embodiment of the present disclosure, which includes an alternating current power quality screening modulator, a direct current power quality screening modulator and a power coordination module, where
an alternating current bus is connected to a power quality-insensitive load alternating current bus via the alternating current power quality screening modulator;
a direct current bus is connected to a power quality-insensitive load direct current bus via the direct current power quality screening modulator;
the alternating current power quality screening modulator and the direct current power quality screening modulator are connected to the power coordination module; and
the power coordination module is configured to receive parameters of buses detected by the alternating current power quality screening modulator and the direct current power quality screening modulator, perform optimization calculation to obtain optimal solutions of a voltage on the power quality-insensitive load alternating current bus and a voltage on the power quality-insensitive load direct current bus, and issue an instruction to control the alternating current power quality screening modulator and the direct current power quality screening modulator to adjust the voltage on the power quality-insensitive load alternating current bus and the voltage on the power quality-insensitive load direct current bus.

Preferably, the alternating current/direct current home smart micro-grid coordination system according to this embodiment may further include a power storage module which is connected to the direct current power quality screening modulator.

Preferably, the power quality-insensitive load alternating current bus may be connected to an alternating current power quality-insensitive load;
the power quality-insensitive load direct current bus may be connected to a direct current power quality-insensitive load;
the alternating current bus may be connected to an alternating current power quality-sensitive load; and
the direct current bus may be connected to a direct current power quality-sensitive load.

An alternating current/direct current home smart micro-grid system is further provided according to an embodiment of the present disclosure, which includes the above alternating current/direct current home smart micro-grid coordination system, the alternating current bus, an alternating current subnet, the direct current bus, a direct current subnet, a new energy direct current subnet and a bi-directional impedance AC/DC converter module, where
the alternating current subnet includes the alternating current power quality-sensitive load, the alternating current power quality-insensitive load and the alternating current power quality screening modulator;
the direct current subnet includes the direct current power quality-sensitive load, the direct current power quality-insensitive load and the direct current power quality screening modulator;
the alternating current bus is connected to a mains supply and the alternating current subnet;
the direct current bus is connected to the new energy direct current subnet and the direct current subnet; and
the alternating current bus is connected to the direct current bus via the bi-directional impedance AC/DC converter module.

Preferably, the new energy direct current subnet may be a combination of new energy direct current modules, which include a photovoltaic module and a wind power module.

Preferably, the mains supply may be connected to the alternating current bus via an anti-islanding switch.

An operation method of a home smart micro-grid system is provided according to an embodiment of the present disclosure, which is performed by the above home smart micro-grid coordination system in cooperation with the above home smart micro-grid system, where the operation method includes:
receiving, by the power coordination module, voltage and current parameters of the alternating current bus and voltage and current parameters of the power quality-insensitive load alternating current bus detected by the alternating current power quality screening modulator, as well as voltage and current parameters of the direct current bus and voltage and current parameters of the power quality-insensitive load direct current bus detected by the direct current power quality screening modulator;
performing, by the power coordination module, optimization calculation based on the voltage and current parameters of the alternating current bus, the voltage and current parameters of the power quality-insensitive load alternating current bus, the voltage and current parameters of the direct current bus, and the voltage and current parameters of the power quality-insensitive load direct current bus, to obtain optimal solutions of the voltage on the power quality-insensitive load alternating current bus and the voltage on the power quality-insensitive load direct current bus; and
adjusting, by the power coordination module based on the optimal solutions, the voltage on the power quality-insensitive load alternating current bus with the alternating current power quality screening modulator, and the voltage on the power quality-insensitive load direct current bus with the direct current power quality screening modulator.

Preferably, the performing the optimization calculation may include:
performing the optimization calculation with minimization of a sum of power losses of the alternating current power quality screening modulator, the direct current power quality screening modulator and the bi-directional impedance AC/DC converter as an optimization target, and the home smart micro-grid system being purely resistive with respect to a mains supply and being maintained at constant power in a time-division manner, and 100% of new energy being connected to a power grid as constraint conditions.

Preferably, the home smart micro-grid system may further include the power storage module, and the operation method of a home smart micro-grid system may include:
receiving, by the power coordination module, the voltage and current parameters of the alternating current bus and the voltage and current parameters of the power quality-insensitive load alternating current bus detected by the alternating current power quality screening modulator, as well as the voltage and current parameters of the power storage module, the voltage and current parameters of the direct current bus, and the voltage and current parameters of the power quality-insensitive load direct current bus detected by the direct current power quality screening modulator;
performing, by the power coordination module, the optimization calculation based on the voltage and current parameters of the alternating current bus, the voltage and current parameters of the power quality-insensitive load alternating current bus, the voltage and current parameters of the direct current bus, the voltage and current parameters of the power storage module, and the voltage and current parameters of the power quality-insensitive load direct current bus, to obtain optimal solutions of the voltage on the power quality-insensitive load alternating current bus, the voltage on the power quality-insensitive load direct current bus, as well as charge and discharge power of the power storage module; and
adjusting, by the power coordination module based on the optimal solutions, the voltage on the power quality-insensitive load alternating current bus with the alternating current power quality screening modulator, and the voltage on the power quality-insensitive load direct current bus as well as the charge and discharge power of the power storage module with the direct current power quality screening modulator.

Preferably, the performing the optimization calculation may include:
performing the optimization calculation with minimization of a sum of power losses of the alternating current power quality screening modulator, the direct current power quality screening modulator, the bi-directional impedance AC/DC converter and the power storage module, and maximization of service life of the power storage module as optimization targets, and the home smart micro-grid system being purely resistive with respect to the mains supply and being maintained at constant power in a time-division manner, and 100% of new energy being connected to a power grid as constraint conditions.

As can be seen from the above technical solutions, the embodiments of the present disclosure have the following advantages.

An alternating current/direct current home smart micro-grid coordination system is provided according to an embodiment of the present disclosure. The power coordination module receives parameters of buses detected by power quality screening modulators, performs the optimization calculation, and then controls the power quality screening modulators to adjust currents, voltages and power on the buses, thereby balancing random fluctuation of power from new energy power sources, achieving stable operation of the alternating current/direct current home micro-grid system, and addressing the technical issue in the conventional technology that the intermittency of the conventional new energy has an impact on the power grid. In addition, an alternating current/direct current home smart micro-grid system based on the alternating current/direct current home smart micro-grid coordination system is further provided according to an embodiment of the present disclosure for solving the technical issue in the conventional technology that an alternating current needs to be converted before being supplied to a direct current load, and a direct current need to be converted two times before being supplied to a direct current load. A coordination method for the alternating current/direct current home smart micro-grid system is provided according to an embodiment of the present disclosure. With the coordination method, the power coordination module analyzes the parameters of the buses, performs the optimization calculation, and adjusts the voltages, currents and power, so that the alternating current/direct current home micro-grid system can operate stably, 100% of new energy can be connected to the power grid, and the alternating current/direct current home smart micro-grid coordination system is purely resistive and is maintained at constant power in a time-division manner with respect to the mains supply.

### BRIEF DESCRIPTION OF THE DRAWINGS

The drawings to be used in the description of the embodiments of the application or the conventional technology will be described briefly as follows, so that the technical solutions according to the embodiments of the present application or according to the conventional technology will become clearer. It is apparent that the drawings in the following description only illustrate some embodiments of the present application. For those skilled in the art, other drawings may be obtained according to these drawings without any creative work.

FIG. 1 is a schematic diagram showing a structure of a conventional home circuit for illustrating the background in the present disclosure;

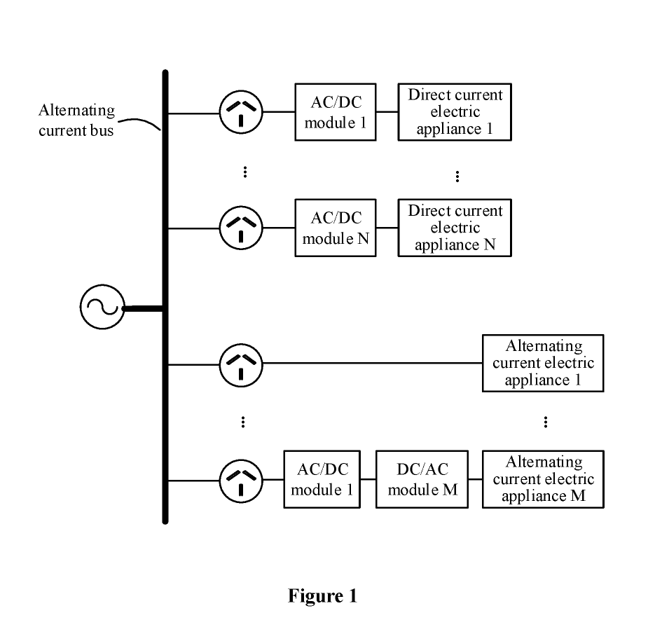

FIG. 2 is a schematic diagram showing a structure of a conventional new energy home micro-grid circuit for illustrating the background in the present disclosure;

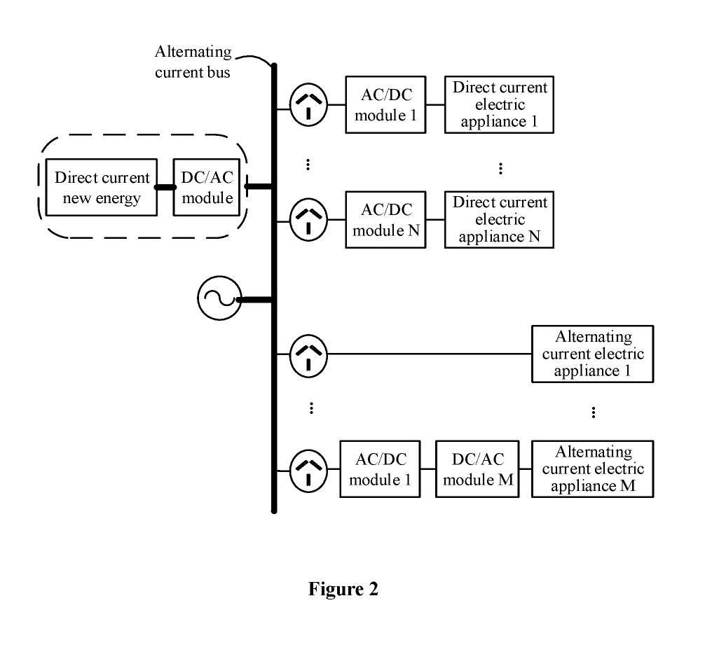

FIG. 3 is a schematic diagram showing a principle of an alternating current/direct current home smart micro-grid coordination system according to an embodiment of the present disclosure;

FIG. 4 is a schematic diagram showing a principle of an alternating current/direct current home smart micro-grid system according to an embodiment of the present disclosure;

FIG. 5 is a flowchart of an operation method of an alternating current/direct current home smart micro-grid system according to an embodiment of the present disclosure; and

FIG. 6 is a flowchart of an operation method of an alternating current/direct current home smart micro-grid system according to another embodiment of the present disclosure.

### Reference Numerals are as Follows.

1 represents a power coordination module; 2 represents an alternating current power quality screening modulator; 3 represents a direct current power quality screening modulator; 4 represents a power storage module; 5 represents an alternating current power quality-insensitive load; 6 represents an alternating current power quality-sensitive load; 7 represents a direct current power quality-insensitive load; 8 represents a direct current power quality-sensitive load; and 9 represents a bi-directional impedance AC/DC converter module.

### DETAILED DESCRIPTION OF THE EMBODIMENTS

An alternating current/direct current home smart micro-grid coordination system and an operation method of the alternating current/direct current home smart micro-grid coordination system are provided according to the embodiments of present disclosure, for balancing random fluctuation of power from new energy power sources, achieving stable operation of the alternating current/direct current home micro-grid, and addressing a technical issue in the conventional technology that the intermittency of conventional new energy has an impact on the power grid, such that 100% of new energy can be connected to the power grid, and the alternating current/direct current home smart micro-grid coordination system is purely resistive and is maintained at constant power in a time-division manner with respect to a mains supply.

In order to make the object, features and advantages of the present disclosure more apparent and easier to be understood, technical solutions according to embodiments of the present disclosure are described clearly and completely hereinafter in conjunction with drawings used in the embodiments of the present disclosure. Apparently, the described embodiments are only some embodiments of the present disclosure rather than all the embodiments. Any other embodiments obtained by those skilled in the art based on the embodiments of the present disclosure without any creative work fall in the scope of protection of the present disclosure.

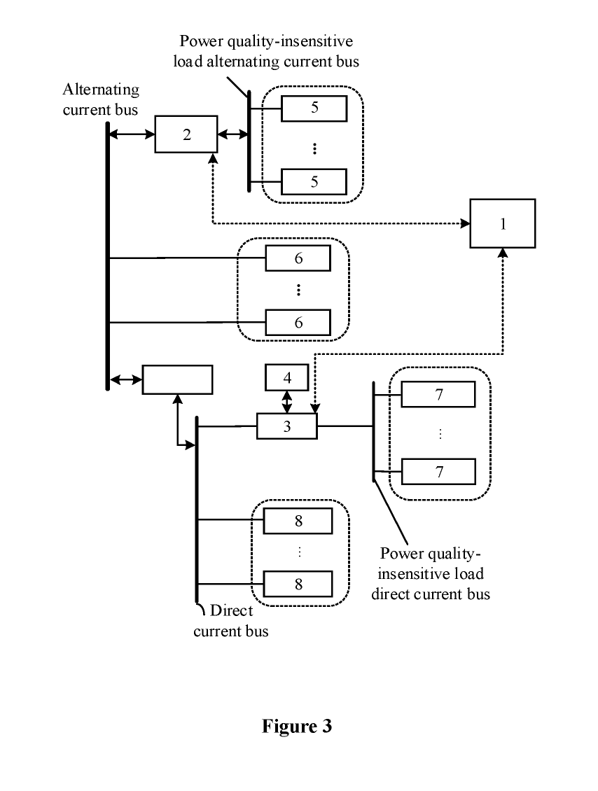

As shown in FIG. 3, an alternating current/direct current home smart micro-grid coordination system is provided according to an embodiment of the present disclosure, which includes an alternating current power quality screening modulator 2, a direct current power quality screening modulator 3 and a power coordination module 1.

An alternating current bus is connected to a power quality-insensitive load alternating current bus via the alternating current power quality screening modulator 2.

A direct current bus is connected to a power quality-insensitive load direct current bus via the direct current power quality screening modulator 3.

The alternating current power quality screening modulator 2 and the direct current power quality screening modulator 3 are connected to the power coordination module 1.

The power coordination module 1 is configured to receive parameters of buses detected by the alternating current power quality screening modulator 2 and the direct current power quality screening modulator 3, perform optimization calculation to obtain optimal solutions of a voltage on the power quality-insensitive load alternating current bus and a voltage on the power quality-insensitive load direct current bus, and issue an instruction to control the alternating current power quality screening modulator 2 and the direct current power quality screening modulator 3 to adjust the voltage on the power quality-insensitive load alternating current bus and the voltage on the power quality-insensitive load direct current bus.

It is to be noted that, with the embodiment of the present disclosure, 100% of new energy can be connected to the power grid, and the alternating current/direct current home smart micro-grid coordination system is purely resistive and is maintained at constant power in a time-division manner with respect to the mains supply.

The alternating current/direct current home smart micro-grid coordination system according to the embodiment of the present disclosure further includes a power storage module 4.

The power storage module 4 is connected to the direct current power quality screening modulator 3.

The power quality-insensitive load alternating current bus is connected to an alternating current power quality-insensitive load 5.

The power quality-insensitive load direct current bus is connected to a direct current power quality-insensitive load 7.

The alternating current bus is connected to an alternating current power quality-sensitive load 6.

The direct current bus is connected to a direct current power quality-sensitive load 8.

Specifically, the alternating current power quality-sensitive load 6 is a load having a high requirement on power quality. The alternating current power quality-insensitive load 5 is a load having a low requirement on power quality. The power quality includes the accuracy and stability of a voltage and a current.

For example, the alternating current power quality-sensitive load 6 may be an electric cooker, a computer, a washing machine, a television, a fan, and on the like. The alternating current power quality-insensitive load 5 may be a water heater, an electric blanket, an electric kettle, a building ice detector, and the like.

The concepts of the direct current power quality-sensitive load 8 and the direct current power quality-insensitive load 7 are similar to that of the alternating current power quality-sensitive load 6 and the alternating current power quality-insensitive load 5, and are not described in detail herein, since a difference between the alternating current and the direct current can be clearly recognized by those skilled in the art.

The alternating current/direct current home smart micro-grid coordination system according to an embodiment of the present disclosure is described above in detail. Next, an alternating current/direct current home smart micro-grid system according to an embodiment of the present disclosure is described below in detail.

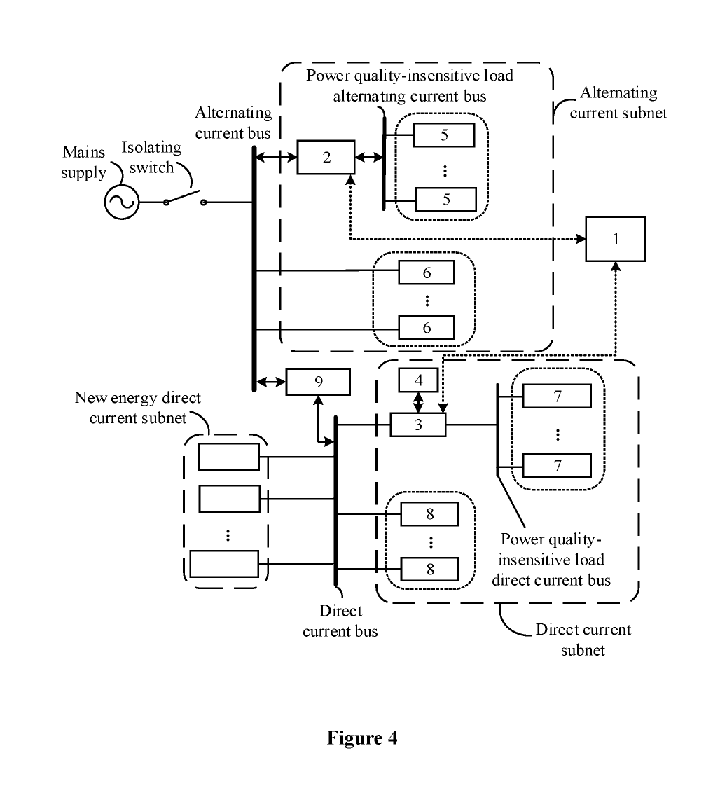

As shown in FIG. 4, an alternating current/direct current home smart micro-grid system is further provided according to an embodiment of the present disclosure, which includes the above alternating current/direct current home smart micro-grid coordination system. In addition, the alternating current/direct current home smart micro-grid system further includes the alternating current bus, an alternating current subnet, the direct current bus, a direct current subnet, a new energy direct current subnet and a bi-directional impedance AC/DC converter module 9.

The alternating current subnet includes the alternating current power quality-sensitive load 6, the alternating current power quality-insensitive load 5 and the alternating current power quality screening modulator 2.

The direct current subnet includes the direct current power quality-sensitive load 8, the direct current power quality-insensitive load 7 and the direct current power quality screening modulator 3.

The alternating current bus is connected to the mains supply and the alternating current subnet.

The direct current bus is connected to the new energy direct current subnet and the direct current subnet.

The alternating current bus is connected to the direct current bus via the bi-directional impedance AC/DC converter module 9.

The new energy direct current subnet is a combination of new energy direct current modules, which includes a photovoltaic module and a wind power module.

The mains supply is connected to the alternating current bus via an anti-islanding switch.

The alternating current/direct current home smart micro-grid system according to an embodiment of the present disclosure is described above in detail. Next, an operation method of an alternating current/direct current home smart micro-grid system according to an embodiment of the present disclosure is described below in detail.

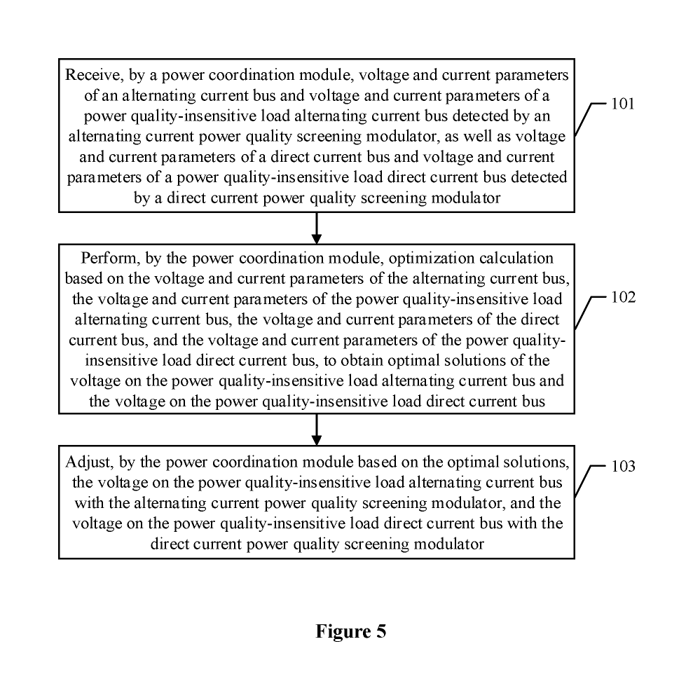

As shown in FIG. 5, an operation method of a home smart micro-grid system provided according to an embodiment of the present disclosure is performed by the above home smart micro-grid coordination system in cooperation with the above home smart micro-grid system, and includes the following steps 101 to 103.

In 101, the power coordination module receives voltage and current parameters of the alternating current bus and voltage and current parameters of the power quality-insensitive load alternating current bus detected by the alternating current power quality screening modulator, as well as voltage and current parameters of the direct current bus and voltage and current parameters of the power quality-insensitive load direct current bus detected by the direct current power quality screening modulator.

In 102, the power coordination module performs optimization calculation based on the voltage and current parameters of the alternating current bus, the voltage and current parameters of the power quality-insensitive load alternating current bus, the voltage and current parameters of the direct current bus, and the voltage and current parameters of the power quality-insensitive load direct current bus, to obtain optimal solutions of the voltage on the power quality-insensitive load alternating current bus and the voltage on the power quality-insensitive load direct current bus.

In 103, the power coordination module adjusts, based on the optimal solutions, the voltage on the power quality-insensitive load alternating current bus with the alternating current power quality screening modulator, and the voltage on the power quality-insensitive load direct current bus with the direct current power quality screening modulator.

The performing the optimization calculation in the above step 102 may include:

performing the optimization calculation with minimization of a sum of power losses of the alternating current power quality screening modulator, the direct current power quality screening modulator and the bi-directional impedance AC/DC converter as an optimization target, and the home smart micro-grid system being purely resistive with respect to the mains supply and supplies a constant power in a time-division manner, and 100% of new energy being connected to a power grid as constraint conditions.

It is to be noted that, in the process of adjusting the voltage on the power quality-insensitive load alternating current bus with the alternating current power quality screening modulator and adjusting the voltage on the power quality-insensitive load direct current bus with the direct current power quality screening modulator, an adjuster is used to adjust a voltage, active power and reactive power of an insensitive load to achieve stability of a voltage, active power and reactive power of a sensitive load.

It is to be noted that the power being constant in a time-division manner indicates that the home smart micro-grid system is maintained at constant power with respect to the mains supply during a time period. For example, the power required from the mains supply is 1000W from 6 am to 8 am. The time-division indicates that the constant power can be maintained at different constant values in different time periods.

The operation method of the home smart micro-grid system according to an embodiment of the present disclosure is described above in detail. Next, an operation method of an alternating current/direct current home smart micro-grid system according to another embodiment of the present disclosure is described below in detail.

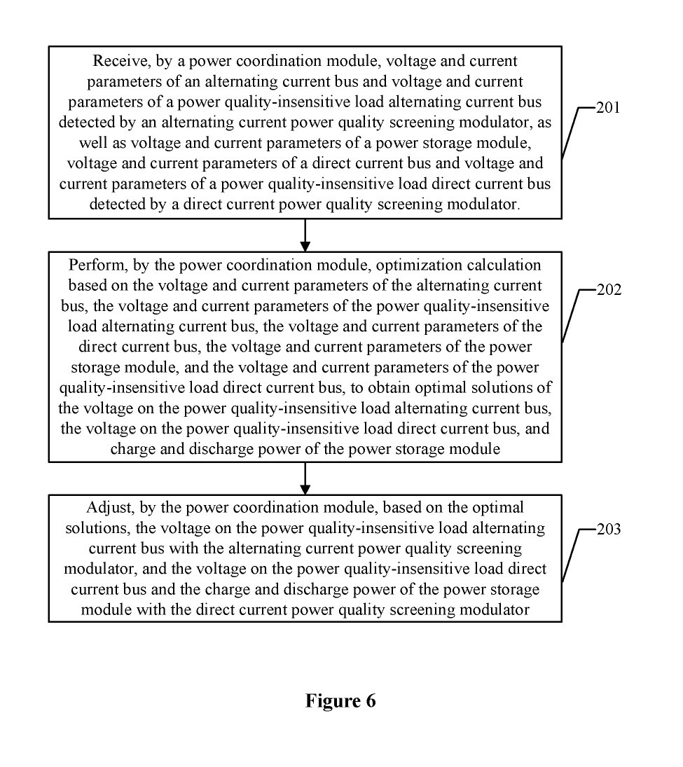

As shown in FIG. 6, an operation method of an alternating current/direct current home smart micro-grid system is provided according to another embodiment of the present disclosure. The method is performed by a home smart micro-grid coordination system including a power storage module in cooperation with a home smart micro-grid system. The operation method of the home smart micro-grid system includes the following steps 201 to 203.

In 201, the power coordination module receives voltage and current parameters of the alternating current bus and voltage and current parameters of the power quality-insensitive load alternating current bus detected by the alternating current power quality screening modulator, as well as voltage and current parameters of the power storage module, voltage and current parameters of the direct current bus and voltage and current parameters of the power quality-insensitive load direct current bus detected by the direct current power quality screening modulator.

In step 202, the power coordination module performs optimization calculation based on the voltage and current parameters of the alternating current bus, the voltage and current parameters of the power quality-insensitive load alternating current bus, the voltage and current parameters of the direct current bus, the voltage and current parameters of the power storage module, and the voltage and current parameters of the power quality-insensitive load direct current bus, to obtain optimal solutions of the voltage on the power quality-insensitive load alternating current bus, the voltage on the power quality-insensitive load direct current bus, and charge and discharge power of the power storage module.

In step 203, the power coordination module adjusts, based on the optimal solutions, the voltage on the power quality-insensitive load alternating current bus with the alternating current power quality screening modulator, and adjusts the voltage on the power quality-insensitive load direct current bus and the charge and discharge power of the power storage module with the direct current power quality screening modulator.

The process of performing the optimization calculation in the above step 202 may include:

performing the optimization calculation with minimization of a sum of power losses of the alternating current power quality screening modulator, the direct current power quality screening modulator, the bi-directional impedance AC/DC converter and the power storage module, and maximization of service life of the power storage module as optimization targets, and the home smart micro-grid system being purely resistive and being maintained at constant power in a time-division manner with respect to the mains supply, and 100% of new energy being connected to a power grid as constraint conditions.

The home smart micro-grid coordination method according to an embodiment of the present disclosure is described above in detail. Next, an alternating current/direct current home smart micro-grid system and an operation method of the alternating current/direct current home smart micro-grid system according to another embodiment of the present disclosure are described below in detail.

An alternating current/direct current home smart micro-grid system and an operation method of the alternating current-direct current home smart micro-grid system are provided according to another embodiment of the present disclosure, which include a mains supply interface, an anti-islanding switch, an alternating current bus, an alternating current subnet, a direct current bus, a direct current subnet, a new energy direct current subnet, the bi-directional impedance AC/DC converter module 9 and the power coordination module 1, as well as an operation method thereof.

The mains supply interface is connected to the anti-islanding switch, and the anti-islanding switch is connected to the alternating current bus.

The alternating current bus is connected to the alternating current subnet.

The bi-directional impedance AC/DC converter module 9 is connected between the alternating current bus and the direct current bus for performing energy exchange.

The new energy direct current subnet is connected to the direct current bus.

The direct current subnet is connected to the direct current bus.

The power coordination module 1 is connected to the alternating current subnet and the direct current subnet, for performing coordination control of the power.

The alternating current subnet in the alternating current/direct current home smart micro-grid system according to another embodiment of the present disclosure may include the alternating current power quality screening modulator 2, a power quality-insensitive load alternating current bus, N alternating current power quality-insensitive load interfaces, a voltage and current detection module on the alternating current bus, and M alternating current power quality-sensitive load interfaces.

The alternating current power quality screening modulator 2 is connected between the alternating current bus and the power quality-insensitive load alternating current bus.

The N alternating current power quality-insensitive load interfaces are connected to the power quality-insensitive load alternating current bus.

The M alternating current power quality-sensitive load interfaces are connected to the alternating current bus.

The alternating current power quality-sensitive load 6 may include an electric cooker, a computer, a washing machine, a television, a fan, and the like.

The alternating current power quality-insensitive load 5 may include a water heater, an electric blanket, an electric kettle, a building ice detector, and the like.

The concepts of the direct current power quality-sensitive load 8 and the direct current power quality-insensitive load 7 are similar to that of the alternating current power quality-sensitive load 6 and the alternating current power quality-insensitive load 5, and are not described in detail herein, since a difference between the alternating current and the direct current can be clearly recognized by those skilled in the art.

The voltage and current detection module acquires a signal from the alternating current bus and transmits the signal to the power coordination module, for detection of the alternating current bus in a case that the alternating current power quality screening modulator 2 cannot detect the alternating current bus or the alternating current power quality screening modulator 2 is not designed to detect the alternating current bus.

The direct current subnet in the alternating current/direct current home smart micro-grid according to another embodiment of the present disclosure may include the direct current power quality screening modulator, the power storage module, a voltage and current detection module on the direct current bus, the power quality-insensitive load direct current bus,

U direct current power quality-insensitive load interfaces, and V direct current power quality-sensitive load interfaces.

The direct current power quality screening modulator is connected between the direct current bus and the power quality-insensitive load direct current bus.

The U direct current power quality-insensitive load interfaces are connected to the power quality-insensitive load direct current bus.

The V direct current power quality-sensitive load interfaces are connected to the direct current bus.

The power storage module is connected to the direct current power quality screening modulator for performing suitable distribution and modulation of new energy in cooperation with the direct current power quality screening modulator.

The new energy direct current subnet in the alternating current/direct current home smart micro-grid according to another embodiment of the present disclosure may include a photovoltaic module, a wind power module, and other direct current power modules. The new energy modules are connected to the direct current bus.

The bi-directional impedance AC/DC converter module in the alternating current/direct current home smart micro-grid according to another embodiment of the present disclosure indicates that an impedance network is arranged at a direct current bus end, so that the AC/DC converter has a function of being immune to short circuit of the direct current bus, thereby improving robustness of the micro-grid structure.

An aspect of the power coordination module in the alternating current/direct current home smart micro-grid and the operation method thereof according to another embodiment of the present disclosure includes that, the voltage and current detection module transmits the detected signal to the power coordination module, and the alternating current power quality screening modulator detects a voltage, a current and power of the alternating current bus and transmits the voltage, the current and the power to the power coordination module; the alternating current power quality screening modulator detects parameters of alternating current sensitive load interfaces, and transmits the parameters of the alternating current sensitive load interfaces to the power coordination module; and the alternating current power quality screening modulator detects parameters of alternating current insensitive load interfaces, and transmits the parameters of the alternating current insensitive load interfaces to the power coordination module.

The direct current power quality screening modulator detects a voltage, a current and power of the direct current bus and transmits the voltage, the current and the power to the power coordination module; the direct current power quality screening modulator detects parameters of direct current sensitive load interfaces, and transmits the parameters of the direct current sensitive load interfaces to the power coordination module; and the direct current power quality screening modulator detects parameters of direct current insensitive load interfaces, and transmits the parameters of the direct current insensitive load interfaces to the power coordination module.

The direct current power quality screening modulator detects a parameter of the power storage module, and transmits the parameter of the power storage module to the power coordination module.

Upon receiving the above data, the power coordination module performs optimization calculation with the home micro-grid system being purely resistive and being maintained at constant power in a time-division manner with respect to the mains supply and new energy being totally connected to a power grid as constraint conditions, and minimization of a sum of power losses of the alternating current power quality screening modulator, the direct current power quality screening modulator, the bi-directional impedance AC/DC converter and the power storage module and maximization of the service life of the power storage module as optimization targets, to obtain optimal solutions of the voltage on the power quality-insensitive load alternating current bus, the voltage on the power quality-insensitive load direct current bus and charge and discharge power of the power storage module, and respectively transmits the optimal solutions to the alternating current power quality screening modulator and the direct current power quality screening modulator for performing control.

The operation method of the alternating current/direct current home smart micro-grid according to another embodiment of the present disclosure includes maintaining the voltage on the direct current bus at a rating value by controlling the bi-directional impedance AC/DC converter module 9.

It is to be noted that, as compared with conventional technology, according to the present disclosure, a direct current bus and a bi-directional impedance AC/DC converter are added to a conventional grid structure to form a home smart micro-grid in which an alternating current and a direct current are used in combination with each other, loads are classified into power quality-sensitive loads and power quality-insensitive loads, and power of the power quality-insensitive loads are adjusted by a corresponding power quality screening modulator to balance random fluctuation of power generated by new energy power sources, so that the entire micro-grid is purely resistive and is maintained at constant power in a time-division manner with respect to the mains supply while stable operation of the power quality-sensitive loads is ensured, thereby facilitating stable operation of an upper-stage power grid. In addition, the disadvantage of low-efficiency multi-level energy conversion (from direct current to alternating current, then back to direct current) of a conventional new energy module is effectively eliminated.

With the alternating current/direct current home smart micro-grid and the operation method of the alternating current/direct current home smart micro-grid according to the present disclosure, precious power storage resources, i.e., the power quality-insensitive loads, are fully utilized, so that the entire micro-grid is purely resistive and is maintained at constant power in a time-division manner with respect to the mains supply while full utilization of power generated by the new energy power sources is ensured, thereby theoretically achieving zero pollution from the home grid to an upper-stage power grid.

It is to be noted that, according to the present disclosure, 100% of new energy is connected to the power grid, and the alternating current/direct current home smart micro-grid coordination system is purely resistive and is maintained at constant power in a time-division manner with respect to the mains supply.

It may be clearly understood by those skilled in the art that, for ease of description and for simplicity, for an operating process of the system, the apparatus and the unit described above, which is not described herein, one may refer to corresponding processes in the above method embodiment.

As described above, the above embodiments are merely provided for describing the technical solutions of the present application, and are not intended to limit the present application. Although the present application is described in detail with reference to the foregoing embodiments, those skilled in the art should understand that, they can still modify technical solutions described in the foregoing embodiments, or make equivalent substitutions to a part of the technical features; and such modifications or substitutions do not enable the essence of corresponding technical solutions to depart from the scope of the embodiments of the present application.

1. An alternating current/direct current home smart micro-grid coordination system, comprising:
an alternating current power quality screening modulator,
a direct current power quality screening modulator, and
a power coordination module, wherein
an alternating current bus is connected to a power quality-insensitive load alternating current bus via the alternating current power quality screening modulator;
a direct current bus is connected to a power quality-insensitive load direct current bus via the direct current power quality screening modulator;
the alternating current power quality screening modulator and the direct current power quality screening modulator are connected to the power coordination module; and
the power coordination module is configured to receive parameters of buses detected by the alternating current power quality screening modulator and the direct current power quality screening modulator, perform optimization calculation to obtain optimal solutions of a voltage on the power quality-insensitive load alternating current bus and a voltage on the power quality-insensitive load direct current bus, and issue an instruction to control the alternating current power quality screening modulator and the direct current power quality screening modulator to adjust the voltage on the power quality-insensitive load alternating current bus and the voltage on the power quality-insensitive load direct current bus.

2. The alternating current/direct current home smart micro-grid coordination system according to claim 1, further comprising a power storage module which is connected to the direct current power quality screening modulator.

3. The alternating current/direct current home smart micro-grid coordination system according to claim 1, wherein
the power quality-insensitive load alternating current bus is connected to an alternating current power quality-insensitive load;
the power quality-insensitive load direct current bus is connected to a direct current power quality-insensitive load;
the alternating current bus is connected to an alternating current power quality-sensitive load; and
the direct current bus is connected to a direct current power quality-sensitive load.

4. An alternating current/direct current home smart micro-grid system, comprising:
an alternating current/direct current home smart micro-grid coordination system,
an alternating current bus,
an alternating current subnet,
a direct current bus,
a direct current subnet,
a new energy direct current subnet, and
a bi-directional impedance AC/DC converter module, wherein
the alternating current/direct current home smart micro-grid coordination system comprises an alternating current power quality screening modulator, a direct current power quality screening modulator and a power coordination module;
the alternating current bus is connected to a power quality-insensitive load alternating current bus via the alternating current power quality screening modulator;
the direct current bus is connected to a power quality-insensitive load direct current bus via the direct current power quality screening modulator;
the alternating current power quality screening modulator and the direct current power quality screening modulator are connected to the power coordination module;
the power coordination module is configured to receive parameters of buses detected by the alternating current power quality screening modulator and the direct current power quality screening modulator, perform optimization calculation to obtain optimal solutions of a voltage on the power quality-insensitive load alternating current bus and a voltage on the power quality-insensitive load direct current bus, and issue an instruction to control the alternating current power quality screening modulator and the direct current power quality screening modulator to adjust the voltage on the power quality-insensitive load alternating current bus and the voltage on the power quality-insensitive load direct current bus;
the alternating current subnet comprises an alternating current power quality-sensitive load, an alternating current power quality-insensitive load and the alternating current power quality screening modulator;
the direct current subnet comprises a direct current power quality-sensitive load, a direct current power quality-insensitive load and the direct current power quality screening modulator;
the alternating current bus is connected to a mains supply and the alternating current subnet;
the direct current bus is connected to the new energy direct current subnet and the direct current subnet; and
the alternating current bus is connected to the direct current bus via the bi-directional impedance AC/DC converter module.

5. The home smart micro-grid system according to claim 4, wherein the new energy direct current subnet is a combination of new energy direct current modules, which comprise a photovoltaic module and a wind power module.

6. The home smart micro-grid system according to claim 4, wherein the mains supply is connected to the alternating current bus via an anti-islanding switch.

7. An operation method of a home smart micro-grid system, performed by the home smart micro-grid system according to claim 4, wherein the operation method comprises:
receiving, by the power coordination module, voltage and current parameters of the alternating current bus and voltage and current parameters of the power quality-insensitive load alternating current bus detected by the alternating current power quality screening modulator, as well as voltage and current parameters of the direct current bus and voltage and current parameters of the power quality-insensitive load direct current bus detected by the direct current power quality screening modulator;
performing, by the power coordination module, optimization calculation based on the voltage and current parameters of the alternating current bus, the voltage and current parameters of the power quality-insensitive load alternating current bus, the voltage and current parameters of the direct current bus, and the voltage and current parameters of the power quality-insensitive load direct current bus, to obtain optimal solutions of the voltage on the power quality-insensitive load alternating current bus and the voltage on the power quality-insensitive load direct current bus; and
adjusting, by the power coordination module based on the optimal solutions, the voltage on the power quality-insensitive load alternating current bus with the alternating current power quality screening modulator, and the voltage on the power quality-insensitive load direct current bus with the direct current power quality screening modulator.

8. The operation method of a home smart micro-grid system according to claim 7, wherein the performing the optimization calculation comprises:
performing the optimization calculation with minimization of a sum of power losses of the alternating current power quality screening modulator, the direct current power quality screening modulator and the bi-directional impedance AC/DC converter as an optimization target, and the home smart micro-grid system being purely resistive and being maintained at constant power in a time-division manner with respect to a mains supply, and 100% of new energy being connected to a power grid as constraint conditions.

9. The operation method of a home smart micro-grid system according to claim 7, wherein the home smart micro-grid system further comprises the power storage module, and the operation method of a home smart micro-grid system comprises:
receiving, by the power coordination module, the voltage and current parameters of the alternating current bus and the voltage and current parameters of the power quality-insensitive load alternating current bus detected by the alternating current power quality screening modulator, as well as the voltage and current parameters of the power storage module, the voltage and current parameters of the direct current bus, and the voltage and current parameters of the power quality-insensitive load direct current bus detected by the direct current power quality screening modulator;
performing, by the power coordination module, the optimization calculation based on the voltage and current parameters of the alternating current bus, the voltage and current parameters of the power quality-insensitive load alternating current bus, the voltage and current parameters of the direct current bus, the voltage and current parameters of the power storage module, and the voltage and current parameters of the power quality-insensitive load direct current bus, to obtain optimal solutions of the voltage on the power quality-insensitive load alternating current bus, the voltage on the power quality-insensitive load direct current bus, as well as charge and discharge power of the power storage module; and
adjusting, by the power coordination module based on the optimal solutions, the voltage on the power quality-insensitive load alternating current bus with the alternating current power quality screening modulator, and the voltage on the power quality-insensitive load direct current bus as well as the charge and discharge power of the power storage module with the direct current power quality screening modulator.

10. The operation method of a home smart micro-grid system according to claim 9, wherein the performing the optimization calculation comprises:
performing the optimization calculation with minimization of a sum of power losses of the alternating current power quality screening modulator, the direct current power quality screening modulator, the bi-directional impedance AC/DC converter and the power storage module, and maximization of service life of the power storage module as optimization targets, and the home smart micro-grid system being purely resistive and being maintained at constant power in a time-division manner with respect to a mains supply, and 100% of new energy being connected to a power grid as constraint conditions.

11. The alternating current/direct current home smart micro-grid system according to claim 4, wherein the alternating current/direct current home smart micro-grid coordination system further comprises a power storage module which is connected to the direct current power quality screening modulator.

12. The alternating current/direct current home smart micro-grid system according to claim 4, wherein
the power quality-insensitive load alternating current bus is connected to an alternating current power quality-insensitive load;
the power quality-insensitive load direct current bus is connected to a direct current power quality-insensitive load;
the alternating current bus is connected to an alternating current power quality-sensitive load; and
the direct current bus is connected to a direct current power quality-sensitive load.
